(19) United States
(12) Patent Application Publication
(10) Pub. No.: US 2009/0224440 A1
(43) Pub. Date: Sep. 10, 2009

(54) Method and Device for the Extrusion of Tubular Films

(75) Inventor: Martin Backmann, Lengerich (DE)

Correspondence Address: JACOBSON HOLMAN PLLC, 400 SEVENTH STREET N.W., SUITE 600, WASHINGTON, DC, 20004, US

(73) Assignee: WINDMOELLER & HOELSCHER KG, LENGERICH (DE)

(21) Appl. No.: 11/990,496

(22) PCT Filed: Aug. 3, 2006
(86) PCT No.: PCT/EP2006/007719

§ 371 Date: Oct. 20, 2008

(30) Foreign Application Priority Data
Aug. 15, 2005 (DE) 10 2005 038 731.4

(51) Int. Cl. B29C 47/78; B29C 47/20

(52) U.S. Cl. 264/563; 425/143; 425/224

(57) ABSTRACT

The invention describes-an extrusion device (1) for extruding a film tube in a direction (z) of movement, said extrusion device (1) comprising a nozzle head with an annular gap from which the film tube exits and said extrusion device (1) comprising an interior cooling device with which the extruded film tube can be cooled from the inside after its exit from the annular gap.

Novel and inventive is the cooling element, which has the same cross-sectional form as the film tube and which has, in the direction (z) of motion of the extruded film tube, a surface which can be moved.

The invention relates to an extrusion device for extruding a film tube according to the preamble of claim 1 as well as to a process for extruding a film tube according to the preamble of claim 16.

Film tubes are produced in extrusion devices such as are known, for example, from the Applicant's Patent Specification DE 100 48 862 C1. There, a nozzle head is shown to which plastic melt is fed via melt-conveying lines and distributed in the form of a ring within the nozzle head. Starting from the melt-conveying lines the melts are pressed in the transport direction z through an annular gap. Following that, the annular melt solidifies to form a film tube which is then transported further in the transport direction z.

The properties of the film tubes, e.g., the optical and mechanical properties, such as, for example, the transparency or the strength for a given film thickness, depend very strongly on how rapidly the film is cooled after exiting the annular gap of the nozzle head and under the so-called frost line.

The geometrical properties, e.g., the film thickness or the diameter of the film tube, also depend on the cooling rate. In experiments to increase the throughput through the nozzle head, i.e., the production rate, it has been observed that the film tube is still not sufficiently solidified after exiting the nozzle gap, so that it performs a walking motion which leads to a variation of the film tube diameter or the film thickness.

In the past, many efforts have been made to rapidly cool a film tube which has just exited the annular gap. For cooling the film tube there have been regular proposals in the past for extrusion devices in which air or other gaseous fluids have been fed via tubular lines to the interior of the film tube and once again discharged from the interior. The necessary lines lead, as represented in DE 100 48 862 C1, through the nozzle head. Along with the cooling, the air also has the objective of drawing out the film tube from the inside. For this, the air in the interior of the film tube is pressurized.

However, it has proven itself disadvantageous that it is not possible with the extrusion devices from the state of the art specifically to expose the film tube to a cold fluid in such a manner that satisfactory cooling rates are achieved.

It is thus the objective of the present invention to propose an extrusion device and a process with which a film tube can be cooled in a more effective and thus more rapid manner.

According to the invention, this objective is realized by the features of the characterizing parts of claims 1 and 16. According thereto the extrusion device comprises a cooling element which is movable and which has the same cross-sectional form as the film tube.

Due to the fact that the cooling element is moved, a laminar flow adheres to its surface, or its surfaces. With this laminar flow it is prevented that, when the film tube approaches the cooling element, the film tube, or parts thereof, come into contact with the cooling element. The film tube is therefore carried by an air cushion created by the moving cooling element. Since in this case the film tube is guided past the cooling element at a very slight distance from it, down to a few tenths of a millimeter, only a slight amount of fluid remains between the film tube and the cooling element. However, this slight amount of fluid can transport heat very well so that the temperatures of the film tube and cooling element equalize very rapidly. The heat taken up by the cooling element can be dissipated via the fluid discharged by the nozzle head. For this, the cooling element can have a large surface, for example, in the form of cooling ribs. In this way the film tube can then be cooled more rapidly than is possible with devices from the state of the art. The effectiveness of the cooling can be increased still further if the cooling element also has a large surface along which the film is guided. For this it is provided that the cooling element has the same cross-sectional form as the film tube. This is, in particular, of importance when the cooling element is disposed in an area in which the film tube is drawn out, i.e., its diameter is changed in the transport direction z. The cooling element therefore has a form which is adapted to the form of the film tube. Conversely, the cooling element can also be used for the purpose of influencing the form of the film tube. Through the guiding of the film along the surface of the moving cooling element the film tube is held at a constant distance due to the air cushion. With this, assuming a corresponding forming of the cooling element, the film tube can be drawn out. This property can, however, also be exploited to guide the film tube securely. In the past, to guide a film tube the tube was exposed to blown air, where a film tube guided in such a manner was frequently inclined to flattening. It is not ensured thereby that the film tube remains unchanged. Thus, for example, its diameter and/or its thickness can be changed unintentionally.

In an advantageous development of the extrusion device the cooling element has a rotationally symmetric form, for example, a cylindrical form. In particular the cooling element can be a plate along whose peripheral surface the film tube is guided.

In an advantageous development of the invention the temperature of the cooling element can be controlled, i.e., it can be cooled or heated. In this way heat taken from or added to the cooling element is transferred very rapidly to the film tube. With this measure the cooling rate of the film tube can clearly be increased still further. For this the cooling element can be provided with interior lines through which the cooling fluid can be conducted.

Experiments have shown that the smoother the respective surface is, the more stable is the laminar flow or the laminar layer on or at the cooling element, and thus the more stable is the air cushion carrying the film tube. Thus it is preferred to provide the surface which serves for cooling the film tube and/or its guide with a chromium coating. Other measures for smoothing the respective surface are also conceivable, e.g., a mechanical or chemical treatment. On the whole it is advantageous if the roughness depth of the surface does not exceed 0.5 micrometers, in particular 0.2 micrometers.

The cooling element must be set in motion by external forces. This can be done by a drive motor, for example, by an electric motor. Through its shaft such a motor can transfer a drive torque to the cooling element. However, in a preferred form of embodiment the cooling element can also be a component of a rotor which can be driven around a fixed component of a drive motor, in the case of electric machines therefore around the stator. Between the rotor and the fixed component there can be a mechanical bearing assembly, but also a contact-free bearing. In the latter case the rotor is preferably held at a fixed point by magnetic forces.

In a further development of the invention the cooling element is linked in such a manner that the gaseous fluid can be conveyed, in the transport direction of the film tube, past the cooling element. This is particularly advantageous if the fluid is also supposed to develop an additional cooling effect on the other side, in the transport direction, of the cooling element. For this, for example, the cooling element can be connected by rods or spokes to the shaft of the drive motor. If the cooling element is guided around a fixed component, then this fixed component can comprise, for example, the stator of an electric motor, passageways, openings, or the like.

In a further advantageous development of the invention an additional temperature control device is provided, in the transport direction of the film tube, at the level of the cooling element. This temperature control device can be based on the same principle of action as the cooling device of the extrusion device according to the invention, with which the extruded film tube can be cooled from the inside. However, the temperature control device can also expose the exterior of the film tube to a fluid, e.g., to blown air, where the temperature of this fluid can be controlled in order in this way to be able to control the temperature of the outer surface of the film tube. In this arrangement it is possible to expose the film tube to a very strong fluid stream since the film tube is guided by the moving cooling element and the air cushion produced in this way. For this reason it is also possible to vary the fluid stream without having a negative impact on the geometric properties of the film tube. In this way it is possible to structure the cooling of the film tube so as to be more effective and it is possible to improve the guiding of the film tube.

Additional embodiment examples of the invention follow from the description of the object and the claims.

The individual figures show

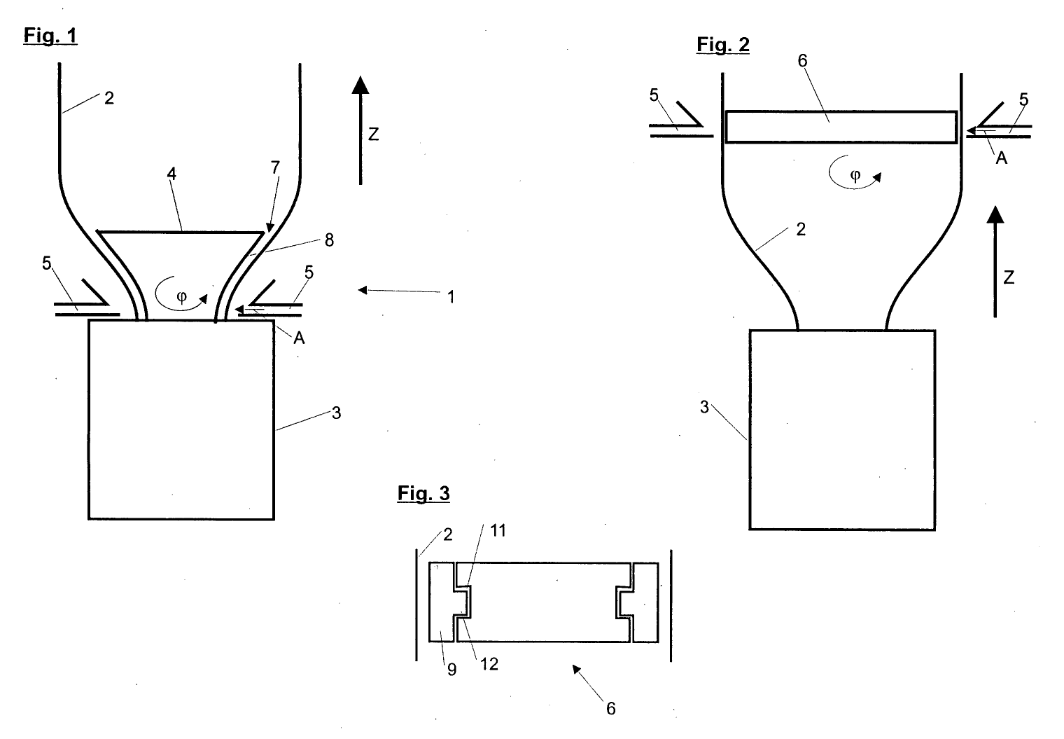

FIG. 1 a side view of a first form of embodiment of an extrusion device according to the invention,

FIG. 2 a side view of a second form of embodiment of an extrusion device according to the invention, and

FIG. 3 a detail view of a cooling element

FIG. 1 shows a schematic representation of extrusion device 1 according to the invention in a side view. The design and the mode of action of the nozzle head 3 have already been gone into briefly in the introductory description. For a more detailed explanation we refer to earlier patents or patent applications, for example, to DE 100 48 862 C1. The nozzle head 3 comprises, though not visible in this view, an annular gap through which the plastic melt exits from the nozzle head and immediately begins to cool since the temperature of the ambient air is usually less than the temperatures prevailing in the nozzle head. Due to this the melt solidifies and subsequently forms a foil tube 2. In order to accelerate the cooling of the melt or of the film tube 2, a cooling element 4 is disposed, in the transport direction z of the film tube 2, directly behind the nozzle head 3. This cooling element 4 can turn in the turning direction φ. The axis of turning is aligned with the axis of symmetry of the film tube. With a sufficiently rapid turning of the cooling element 4 a laminar flow arises on its peripheral surface 8, said laminar flow preventing the inner wall of the film tube 2 from contacting the peripheral surface 8. Between these two a gap 7 thus remains. Expressed differently, an air cushion is formed on the peripheral surface 8 of the cooling element, said air cushion guiding or carrying the film tube 2. The gap 7 between the peripheral surface and the film tube 2 is exaggerated in its representation in the figures. The cooling element 4 can be formed as a one-piece body. Since the film tube 2 is formed so as to be rotationally symmetric with respect to the transport direction z, the cooling element is also formed so as to be rotationally symmetric. As can be inferred from FIG. 1, the visible cross section of the cooling element 4 has the same form as the film tube 2. Expressed in other words, the gap 7 has a constant thickness. In order to achieve an improved cooling effect, blown-air nozzles 5 can be disposed outside of the film tube 2. Several blown-air nozzles 5 can be distributed around the periphery of the film tube 2. Through the blown-air nozzles 5 blown-air streams which run in the direction of the arrow A can be directed onto the outer periphery of the film tube 2. Several blown-air nozzles 5 can also be disposed subsequently in the transport direction z of the film tube 2. However, an advantageous effect is achieved when the blown-air nozzles 5 expose the outer wall of the film tube to blown air at those points at which the inner wall of the film tube is guided and/or cooled by the cooling element 4.

FIG. 2 shows the schematic side view of an additional extrusion device in which a cooling element 6 is disposed, in the transport direction z of the film tube 2, at a distance from the nozzle head 3. In this area the diameter of the film tube 2 no longer changes in the transport direction z so that the cooling element 6 is formed as a cylinder. The cooling element 6 represented has, in addition, the form of a plate, that is, the diameter of the cooling element 6 is larger than its extension in the transport direction z. The cooling element 4 can also be formed as a plate. Blown-air nozzles 5 can also be provided in this form of embodiment.

In FIG. 3 an additional form of embodiment of a cooling element 6 is represented. This cooling element is disposed within the tubular film 2. The stator 10 of the cooling element 6 is fastened, in a manner not represented, to the blowing head 3. On its outer periphery the stator 10 is provided with a groove 11. Around the stator 10 an annular rotor 9 is disposed which comprises on its inner surface an encircling ridge 12 which engages in the groove 11. The ridge 12 is held without contact in the groove by a suitable force, e.g., a magnetic force. A magnetic force can also provide for the drive of the rotor 9 so that it rotates about the stator 10.

It is obvious that the forms of embodiment of FIGS. 1, 2, and 3 can be combined with one another.

LIST OF REFERENCE NUMBERS

| | |
|---|---|
| 1 | Extrusion device |
| 2 | Film tube |
| 3 | Nozzle head |
| 4 | Cooling element |
| 5 | Blown-air nozzle |
| 6 | Cooling element |
| 7 | Gap |
| 8 | Peripheral surface |
| 9 | Rotor |
| 10 | Stator |
| 11 | Groove |
| 12 | Ridge |
| Z | Transport direction of the film tube 2 |
| φ | Direction of turning of the cooling element |
| A | Direction of flow of the blown air |

1. Extrusion device (1) for extruding a film tube in a direction (z) of movement, said extrusion device (1) comprising a nozzle head with an annular gap from which the film tube exits and said extrusion device (1) comprising an interior cooling device with which the extruded film tube can be cooled from the inside after its exit from the annular gap, where at least one cooling element is provided which has the same cross-sectional form as the film tube and which has, in the direction (z) of movement of the extruded film tube, a surface which can be moved
characterized by the fact that
the cooling element is a component of a rotor which rotates around a stator, where the rotor can be guided without contact around the stator.

2. Extrusion device according to the foregoing claim,
characterized by the fact that
the rotor can be guided and driven by the stator via magnetic forces.

3. Extrusion device (1) according to claim 1,
characterized by the fact that
the cooling element is shaped so as to be rotationally symmetric.

4. Extrusion device (1) according to claim 1,
characterized by the fact that
the cooling element is shaped to have the form of a cylinder.

5. Extrusion device (1) according to claim 1,
characterized by the fact that
the direction of movement of the surface of the cooling element runs parallel to the interior surface of the film tube and transverse to the transport direction (z) of the film tube.

6. Extrusion device according to claim 1,
characterized by the fact that
the temperature of the cooling element can be controlled.

7. Extrusion device according to claim 1,
characterized by the fact that
the at least one cooling element can be exposed to a fluid with which the temperature of the cooling element can be influenced.

8. Extrusion device according to claim 1,
characterized by the fact that
the surface of the cooling element is chromium-coated.

9. Extrusion device according to claim 1,
characterized by the fact that
the surface of the cooling element has a roughness depth of at most 0.5 micrometers.

10. Extrusion device according to claim 1,
characterized by the fact that
the surface of the cooling element has a roughness depth of at most 0.2 micrometers.

11. Extrusion device according to claim 1,
characterized by the fact that
the at least one cooling element is linked in such a manner that the gaseous fluid can be conveyed, in the transport direction (z) of the film tube, past the cooling element.

12. Extrusion device according to claim 1,
characterized by the fact that
a temperature control device is provided, in the transport direction (z) of the film tube, at the level of the at least one cooling means, where the temperature of the exterior of the film tube can be controlled with said temperature control device.

13. Extrusion device according to claim 1,
characterized by the fact that
with the temperature control device the exterior of the film tube can be exposed to a fluid whose temperature can be controlled.

14. Device according to claim 1,
characterized by the fact that
the at least one cooling means is disposed, in the transport direction (z) of the film tube, directly behind the annular gap.

15. Process for extruding a film tube in a direction (z) of movement, said (1) being cooled from inside with an interior cooling device, where at least one cooling element is moved in the interior of the film tube,
characterized by the fact that
the cooling element is a component of a rotor which rotates around a stator, where the rotor is guided around the stator without contact.

16. Process according to claim 15,
characterized by the fact that
the at least one cooling element is moved at a speed of at least 1000 m/min.

17. Process according to claim 1,
characterized by the fact that
the at least one cooling element is moved at a speed of at least 1500 m/min.

18. Process according to claim 16,
characterized by the fact that
the at least one cooling element is moved at a speed of at least 2000 m/min.
